(19) United States
(12) Patent Application Publication
(10) Pub. No.: US 2018/0071771 A1
(43) Pub. Date: Mar. 15, 2018

(54) DETACHING APPARATUS AND DETACHING METHOD

(71) Applicant: SCREEN Holdings Co., Ltd., Kyoto (JP)

(72) Inventors: Itsuki KAJINO, Kyoto (JP); Miyoshi UENO, Kyoto (JP); Mikio MASUICHI, Kyoto (JP); Hiroyuki UENO, Kyoto (JP); Kazuhiro SHOJI, Kyoto (JP)

(21) Appl. No.: 15/676,256

(22) Filed: Aug. 14, 2017

(30) Foreign Application Priority Data
Sep. 13, 2016 (JP) 2016-178523

(51) Int. Cl. B05C 11/00; B05D 1/28; B05C 1/02; B41F 16/00

(52) U.S. Cl. CPC B05C 11/00; B41F 16/00; B05C 1/025; B05D 1/28

(57) ABSTRACT

A first movable body is provided movably in a separation direction and a first engaging member is provided for each suction unit. When the first movable body is moved in the separation direction, the plurality of first engaging members are respectively engaged with the first movable body in the same sequence as an array sequence of the suction units. Thereafter, the suction units are moved in the separation direction together with the first movable body.

### CROSS REFERENCE TO RELATED APPLICATION

The disclosure of Japanese Patent Application No. 2016-178523 filed on Sep. 13, 2016 including specification, drawings and claims is incorporated herein by reference in its entirety.

### BACKGROUND OF THE INVENTION

### 1. Field of the Invention

This invention relates to a detaching apparatus and a detaching method for detaching a second plate-like member from a first plate-like member.

### 2. Description of the Related Art

An invention described in JP2016-10922A is, for example, conventionally known as the above detaching apparatus. In the invention described in JP2016-10922A, an adhesion body formed by holding a blanket (corresponding to a “first plate-like member” of the invention) and a plate or substrate (corresponding to a “second plate-like member” of the invention) in close contact is held on a stage, whereas an upper suction block is provided above the stage. In this upper suction block, a plurality of suction units are arranged in a detachment progress direction with respect to a supporting frame. In each suction unit, a plurality of suction pads are arrayed in a horizontal direction perpendicular to the detachment progress direction and these can be collectively moved in a vertical direction. The suction unit on a most upstream side in the detachment progress direction, out of the plurality of suction units, moves vertically upward while sucking the upper surface of the plate (or substrate) by the suction pads, whereby partial detachment is performed. This “partial detachment” means an operation of detaching a sucked part of the upper surface of the plate (or substrate) sucked by the suction pads from the blanket. Further, following the partial detachment by the suction unit on the most upstream side, the remaining suction units perform the partial detachment in a sequence along the detachment progress direction. In this way, the plate (or substrate) is detached from the blanket in the detachment progress direction.

### SUMMARY OF THE INVENTION

In the invention described in JP2016-10922A, an elevating mechanism for elevating and lowering the suction pads constituting the suction unit in the vertical direction is provided for each suction unit. That is, as many elevating mechanisms as the suction units need to be provided. For example, about six or seven elevating mechanisms are provided to manufacture a liquid crystal display device of G1 size, and about thirteen elevating mechanisms are provided to manufacture a liquid crystal display device of G4 size. This leads to a weight increase of the upper suction block. Thus, a sturdy body frame for supporting the upper suction block is necessary and there is a problem of causing the enlargement of the apparatus. Further, each elevating mechanism is constituted by a ball screw mechanism using a motor as a drive source. This also causes a problem of increasing apparatus cost.

This invention was developed in view of the above problem and aims to reduce the size and cost of a detaching apparatus for detaching a second plate-like member from a first plate-like member.

According to a first aspect of the disclosure, there is provided a detaching apparatus that detaches a second plate-like member, having one principal surface held in close contact with the first plate-like member, from the first plate-like member in a detachment progress direction. The apparatus comprises: a holder configured to hold the first plate-like member; a plurality of suction units arrayed in the detachment progress direction and configured to suck the other principal surface of the second plate-like member; and a detachment control unit configured to cause the detachment of the second plate-like member to progress by performing partial detachment of detaching a sucked part of the second plate-like member sucked by the suction unit from the first plate-like member by moving the suction unit in a separation direction away from the holder in an array sequence of the plurality of suction units, wherein: the detachment control unit includes: a first movable body provided movably in the separation direction; a first mover configured to move the first movable body in the separation direction; and a plurality of first engaging members provided for each suction unit and configured to move the suction unit in the separation direction according to a movement of the first movable body by being engaged with the first movable body moving in the separation direction; and a sequence of timings, at which the plurality of first engaging members are respectively engaged with the first movable body, is the same as the array sequence.

According to a second aspect of the disclosure, there is provided a detaching method that detaches a second plate-like member, having one principal surface held in close contact with the first plate-like member, from the first plate-like member in a detachment progress direction. The method comprises: a holding step of holding the first plate-like member by a holder; and a detaching step of performing partial detachment of detaching a sucked part of the second plate-like member sucked by a suction unit from the first plate-like member by moving the suction unit in a separation direction away from the holder while the other principal surface of the second plate-like member is sucked by the suction unit by a plurality of the suction units arrayed in the detachment progress direction; wherein, in the detaching step, a movable body is moved in the separation direction while the holding step is continued; and an engaging member provided in each suction unit is engaged with the movable body moving in the separation direction and moved together with the movable body in the separation direction in a sequence from the suction unit located on a most upstream side toward the suction unit located on a most downstream side in the detachment progress direction, thereby performing the partial detachment.

In the invention thus configured, the first movable body is provided movably in the separation direction and the first engaging member is provided for each suction unit. When the first movable body is moved in the separation direction by the first mover, the plurality of first engaging members are respectively engaged with the first movable body in the same sequence as the array sequence of the suction units. Thereafter, the suction units are moved in the separation direction together with the first movable body. This causes the partial detachment to be performed in the same sequence as the array sequence of the suction units, thereby detaching the second plate-like member from the first plate-like member. A detaching process can be performed by moving the plurality of section units in the sequence set in advance by one mover in this way. As a result, it is possible to reduce the cost and size of the detaching apparatus.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a perspective view showing a first embodiment of a detaching apparatus according to this invention.

FIG. 2 is a view of the detaching apparatus shown in FIG. 1 viewed from front.

FIG. 3 is a block diagram showing an electrical configuration of the detaching apparatus shown in FIGS. 1 and 2.

FIG. 4 is a flow chart showing a detaching process.

FIGS. 5A to 5D are diagrams showing a positional relationship of each unit in each stage of the process and schematically represents a progress status of the process.

FIGS. 6A and 6B are diagrams showing a second embodiment of the detaching apparatus according to the invention.

FIG. 7 is a diagram showing a third embodiment of the detaching apparatus according to the invention.

FIG. 8 is a side view of the detaching apparatus shown in FIG. 7.

FIG. 9 is a flow chart showing the detaching process in the third embodiment.

FIGS. 10A to 10D are diagrams showing a positional relationship of each unit in each stage during the detaching process in the third embodiment.

### DETAILED DESCRIPTION OF THE PREFERRED EMBODIMENTS

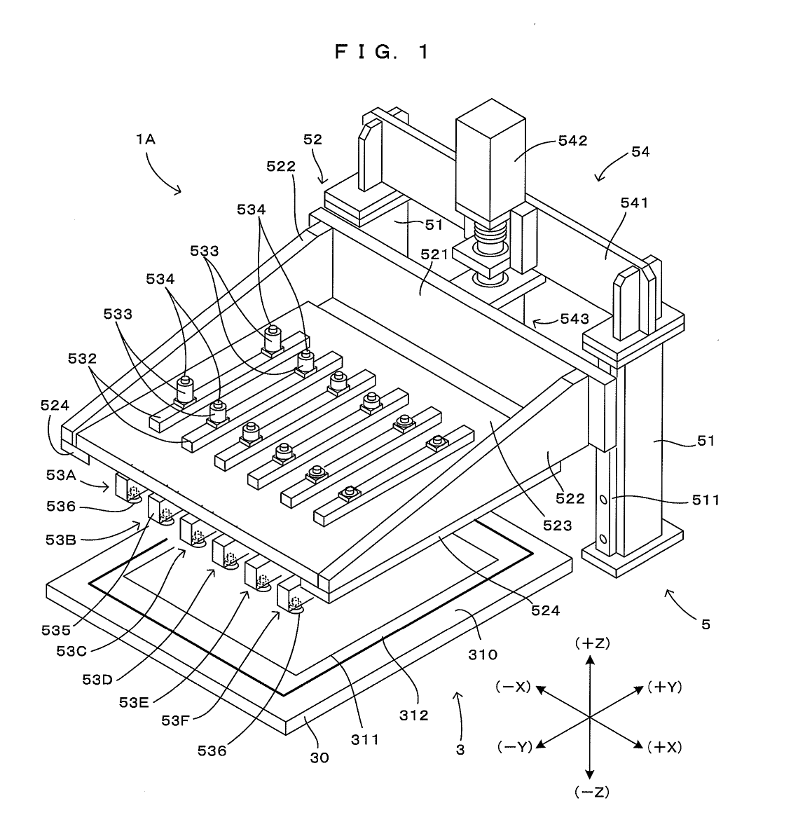

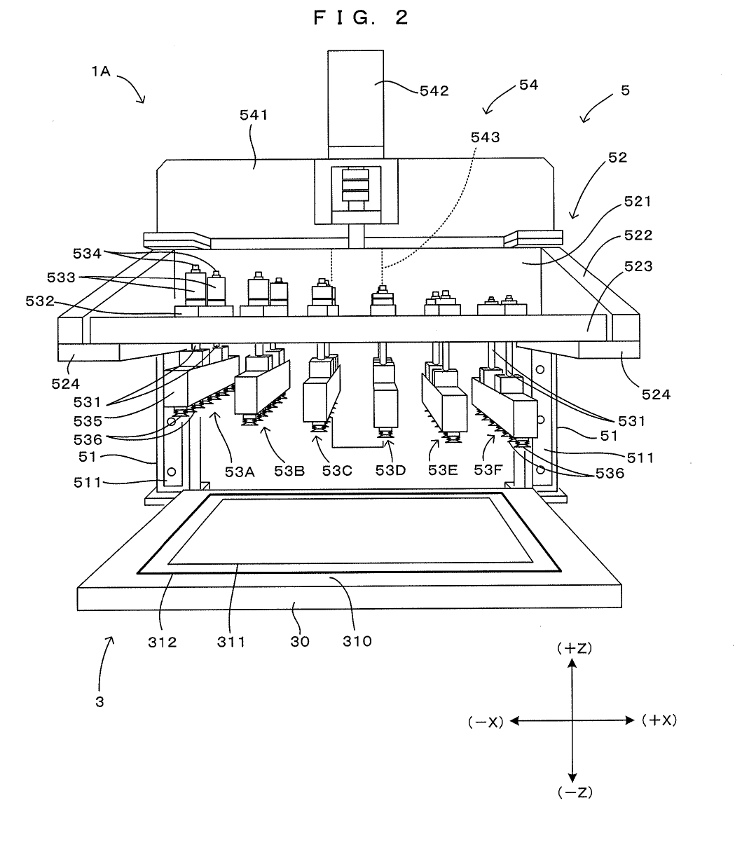

FIG. 1 is a perspective view showing a first embodiment of a detaching apparatus according to this invention. Further, FIG. 2 is a view of the detaching apparatus shown in FIG. 1 viewed from front. XYZ orthogonal coordinate axes are set as shown on a right-lower side of FIG. 1 to show directions in each figure in a unified manner. Here, an XY plane represents a horizontal plane and a Z axis represents a vertical axis. More specifically, a (+Z) direction represents a vertically upward direction.

This detaching apparatus 1A is an apparatus for detaching two plate-like bodies loaded with principal surfaces held in close contact with each other. This apparatus is used, for example, in a part of a printing process for printing a predetermined pattern on a surface of a substrate such as a glass substrate or semiconductor substrate. More specifically, in this printing process, a pattern forming material is uniformly coated to a blanket surface as a carrier for temporarily carrying a pattern to be transferred to a substrate serving as a transfer object (coating step). Further, an applied layer is patterned by pressing a plate surface-processed according to a pattern shape against the applied layer on the blanket (patterning step) to form a pattern layer on the blanket. Furthermore, the pattern layer is finally transferred from the blanket to the substrate by holding the blanket formed with the pattern layer in this way in close contact with the substrate (transfer step) to print the pattern on the substrate.

At this time, this apparatus can be suitably applied to detach the plate and the blanket held in close contact in the patterning step or detach the substrate and the blanket held in close contact in the transfer step. Of course, this apparatus may be used for both purposes or may be used for purposes other than these. For example, application to a detaching process in transferring a thin film carried on a carrier to a substrate is also possible.

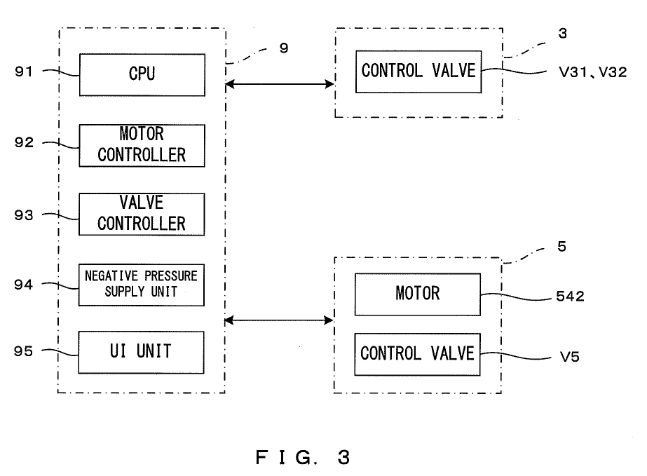

This detaching apparatus 1A is structured such that a stage block 3 and an upper suction block 5 are respectively fixed onto an unillustrated main frame. In FIG. 1, the main frame and a housing are not shown to show an internal structure of the apparatus. Further, this detaching apparatus 1A includes a control unit 9 (FIG. 3) to be described later besides these respective blocks.

The stage block 3 includes a stage 30 for placing an adhered body (hereinafter, referred to as a “work”) formed by holding a plate or substrate and a blanket in close contact. In this embodiment, the stage 30 is formed of a stone surface plate and an upper surface 310 thereof is finished into a substantially horizontal flat surface. This upper surface 310 has a planar size slightly larger than that of the work to be placed. The work is placed on the stage 30 such that an effective area (area where a thin film or pattern is to be formed) of the plate or substrate constituting the work is entirely located in an upper surface central part 311 of the stage 30. A lattice-shaped groove (not shown) is provided in this upper surface central part 311. Further, a vacuum suction groove 312 is provided to surround the upper surface central part 311 and closed by the blanket constituting the work when the work is placed on the stage 30.

The lattice-shaped groove and the vacuum suction groove 312 are connected to a negative pressure supply unit 94 (FIG. 3) via control valves V31, V32 (FIG. 3) as described later and function as suction grooves for sucking and holding the work placed on the stage 30 by having a negative pressure supplied thereto. Since these two types of grooves are not connected on the stage and are connected to the negative pressure supply unit 94 via the control valves V31, V32 independent of each other, suction using only one groove is also possible besides suction using the both grooves.

On the other hand, as shown in FIG. 1, the upper suction block 5 includes two support columns 51, 51 standing from the main frame on a (+Y) side of the stage block 3, a movable body 52 mounted movably in the vertical direction Z with respect to the support columns 51, 51 while covering an upper part of the stage block 3, suction units 53A to 53F mounted movably in the vertical direction Z with respect to the movable body 52 and a mover 54 for driving and moving the movable body 52 in the vertical direction Z.

A guide rail 511 extending in the Z direction is mounted on a side surface on a (−Y) side of each support column 51. Further, a slider (not shown) is mounted slidably in the Z direction on each guide rail 511, and the movable body 52 is mounted to straddle these sliders. More specifically, a plate 521 is attached on a (+Y) side of the movable body 52 and both end parts of the plate 521 in the X direction are respectively fixed to the sliders. Thus, the movable body 52 is moved upward and downward along the Z direction by the mover 54.

This movable body 52 includes a pair of hands 522, 522, a sucking/supporting plate 523 and plate supporting members 524. In the movable body 52, the pair of hands 522, 522 extend in a (−Y) direction from a principal surface of the horizontal plate 521 on a (−Y) side. The hands 522, 522 are respectively fixed to a (+X) side end part and a (−X) side end part of the plate 521 and are separated by a distance equivalent to a width of the stage 30 in the X direction. In the hand 522 on the (+X) side end part, the plate supporting member 524 is mounted on the lower surface of the hand 522 with a (−X) side end part of the plate supporting member 524 projecting further in the (−X) direction than the hand 522 on the (+X) side end part. On the other hand, in the hand 522 on the (−X) side end part, the plate supporting member 524 is mounted on the lower surface of the hand 522 on the (−X) side with a (+X) side end part of the plate supporting member 524 projecting further in the (+X) direction than the hand 522. (−X) and (+X) side end parts of the sucking/supporting plate 523 are respectively supported from below by the (−X) and (+X) side end parts of the plate supporting members 524, and the sucking/supporting plate 523 is fixed to the hands 522, 522 and the plate supporting members 524 in that supported state.

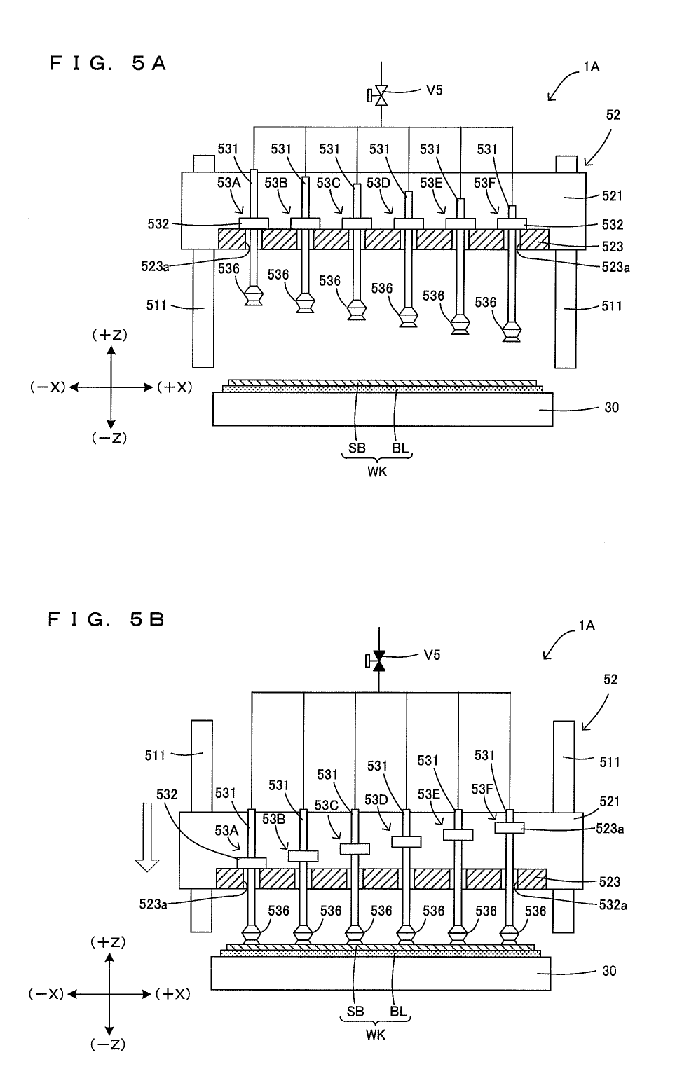

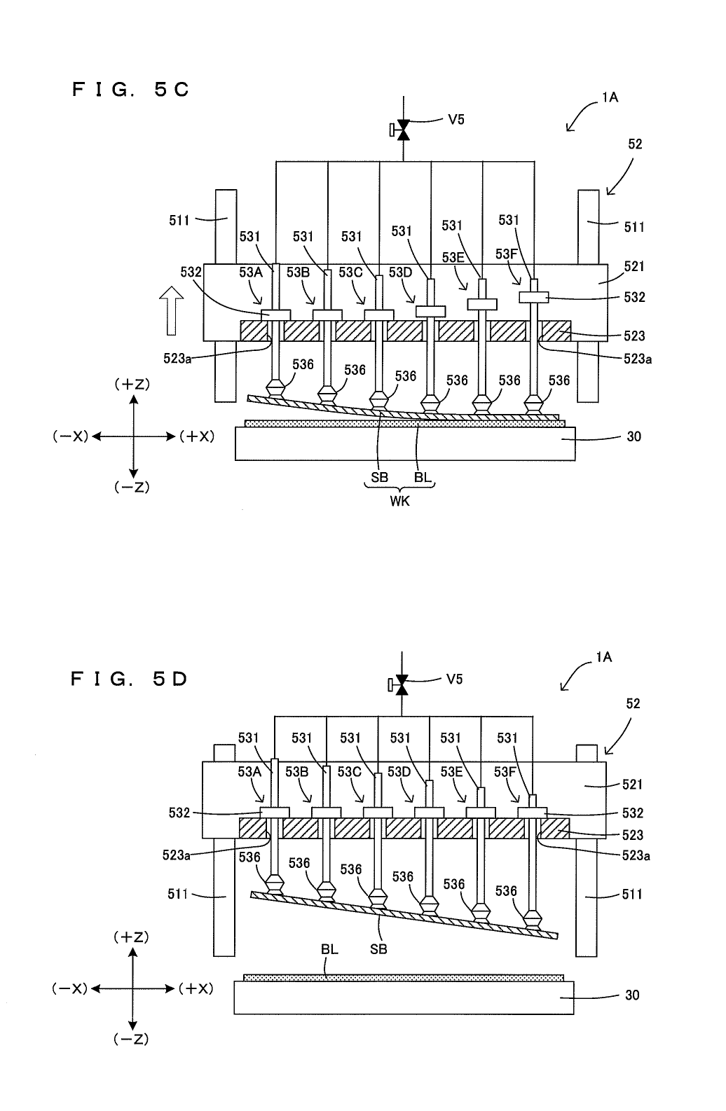

The sucking/supporting plate 523 has a planar size equivalent to the upper surface central part 311 of the stage 30 as shown in FIG. 1, six pairs of through holes (523a, 523a in FIG. 5 to be described later) perforated in the sucking/supporting plate 523 while being separated in the Y direction are arrayed while being separated in the X direction. The suction units 53A to 53F are respectively mounted movably in the vertical direction Z via these six pairs of through holes. Since these suction units 53A to 53F are identically configured, the configuration of the suction unit 53A is described here and the others are denoted by the same reference signs and not described.

The suction unit 53A is provided in the pair of through holes most upstream in the X direction out of the six pairs of through holes. As shown in FIG. 2, two support pipes 531, 531 are respectively fitted into this pair of through holes and movable in the Z direction. Upper end parts of the respective support pipes 531, 531 project upward through the through holes and an engaging member 532 is mounted on these upper end parts. The engaging member 532 is arranged on a side above the sucking/supporting plate 523, i.e. on a (+Z) side. This engaging member 532 has a plate shape having a size longer than a separation distance between the pair of through holes. Thus, the suction unit 53A is supported on the sucking/supporting plate 523 with lower end parts of the support pipes 531, 531 hanging down through the through holes by engaging the engaging member 532 with the upper surface of sucking/supporting plate 523.

Here, as shown in FIGS. 1 and 2, a circular ring-shaped spacer 533 is loosely fitted on a part of the upper end part of each support pipe 531 projecting further upward than the sucking/supporting plate 523, and a nut 534 is mounted on a male screw (not shown) externally threaded on an upper end. As just described, in this embodiment, the Z-direction position of the engaging member 532 with respect to the respective support pipes 531, 531 can be adjusted by changing a Z-direction size of the spacers 533. That is, as shown in FIG. 2, a distance from suction pads to be described next to the engaging member 532 (height position of the suction pads) can be adjusted for each suction unit 53A to 53F.

Lower end parts of the respective support pipes 531, 531 extend downwardly of the sucking/supporting plate 523 though the pair of through holes of the sucking/supporting plate 523. A manifold (not shown) is connected to the lower ends of the support pipes 531, 531. This manifold extends in the Y direction and has the upper and side surfaces covered with a box-shaped case 535. A plurality of branch sections project downward via the box-shaped case 535 from the manifold and a suction pad 536 is attached to each of the branch sections. The respective suction pads 536 are connected to the negative pressure supply unit 94 via the manifold, the support pipes 531 and a control valve V5 (see FIGS. 3, 5A, etc.). Thus, when the control valve V5 is opened in response to an opening command from the control unit 9, a negative pressure is applied to all the suction pads 536 so that the upper surface of the work (upper surface of the plate or substrate) can be sucked.

In the suction units 53A to 53F, the spacers 533 having Z-direction sizes different from each other as described above are used. More specifically, as shown in FIGS. 1 and 2, longest spacers 533 are used on the most upstream side in an array direction X of the suction units 53A to 53F, and the Z-direction sizes of the spacers 533 become smaller toward a downstream side. Thus, when the sucking/supporting plate 523 is positioned at a highest position (see FIGS. 1 and 2), the engaging members 532 are engaged with the sucking/supporting plate 523 and the respective suction pads 536 are positioned at height positions corresponding to the Z-direction sizes of the spacers 533 in all the suction units 53A to 53F. That is, the suction units 53A to 53F are suspended on the sucking/supporting plate 523 by their own weights, the suction pads 536 of the suction unit 53A are located at a height position, the positions of the suction pads 536 become gradually lower along the X direction and, finally, the suction pads 536 of the suction unit 53A are closest to the stage 30.

Since the suction units 53A to 53F are supported by the sucking/supporting plate 523 in this way, the suction units 53A to 53F are elevated and lowered together with the movable body 52 to perform a detaching operation as described in detail later by elevating and lowering the movable body 52 including the sucking/supporting plate 523 in the Z direction by the mover 54. In this way, the mover 54 functions as one constituent of a detachment control unit for controlling the detaching operation. This mover 54 includes, as shown in FIG. 1, a motor supporting plate 541 mounted to connect the support columns 51, 51, a motor 542 fixed to the motor supporting plate 541 and an elevating mechanism 543 for elevating and lowering the movable body 52 along the guide rails 511 by the rotation of the motor 542. Out of these, the elevating mechanism 543 is constituted, for example, by a ball screw mechanism serving as a translating mechanism for translating a rotational movement of the motor 542 into a linear movement. When the motor 542 is rotated in a predetermined direction in response to a lowering command from the control unit 9, the movable body 52 is lowered together with the suction units 53A to 53F in the (−Z) direction by the elevating mechanism 543 to bring all the suction pads 536 into contact with the upper surface of the work on the stage 30 (see FIG. 5B). Conversely, when the motor 542 is rotated in a reverse direction, the movable body 52 is elevated together with the suction units 53A to 53F in the (+Z) direction by the elevating mechanism 543 to perform a detaching operation for the work to detach the plate or substrate from the blanket.

FIG. 3 is a block diagram showing an electrical configuration of the detaching apparatus shown in FIGS. 1 and 2. Each unit of the apparatus is controlled by the control unit 9. The control unit 9 includes a CPU 91 for controlling the operation of the entire apparatus, a motor controller 92 for controlling motors provided in the respective units, a valve controller 93 for controlling valves provided in the respective units, the negative pressure supply unit 94 for generating a negative pressure to be supplied to the respective units, and a user interface (UI) unit 95 for receiving an operation input from a user and notifying a state of the apparatus to the user. The control unit 9 may not include the negative pressure supply unit if a negative pressure supplied from outside such as a factory power source is usable.

The motor controller 92 controls the drive of the motors such as the motor 542 provided in the mover 54. The valve controller 93 controls the control valves 31V, 32V provided in a piping route leading from the negative pressure supply unit 94 to the suction grooves provided in the stage 30 for individually supplying a predetermined negative pressure to these suction grooves and the control valve V5 and the like provided in a piping route leading from the negative pressure supply unit 94 to the respective suction pads 536 for switching the supply and the supply stop of the negative pressure to the respective suction pads 536.

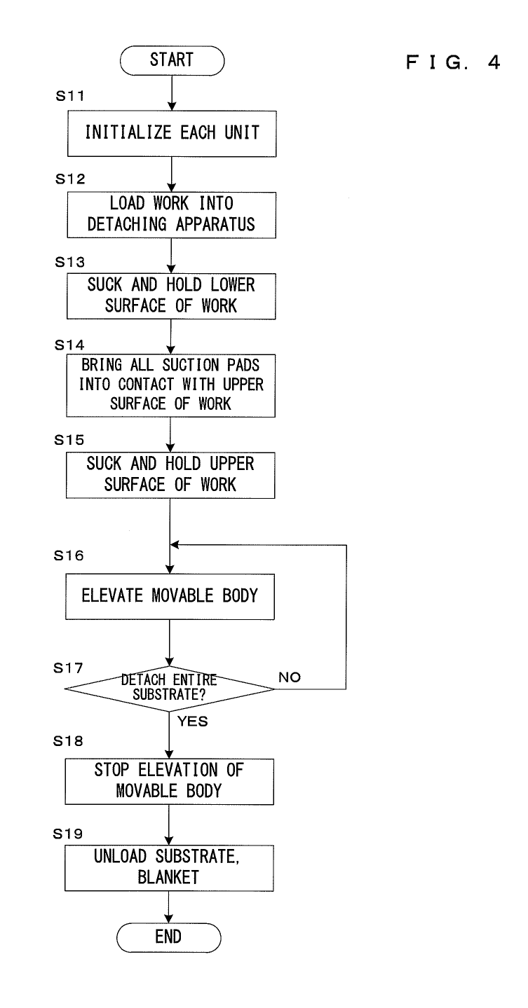

Next, the detaching operation by the detaching apparatus 1A configured as described above is described with reference to FIGS. 4, 5A to 5D. FIG. 4 is a flow chart showing a detaching process. Further, FIGS. 5A to 5D are diagrams showing a positional relationship of each unit in each stage of the process and schematically represents a progress status of the process. The spacers are not shown in FIGS. 5A to 5D. Further, in a symbol showing the control valve V5 in FIGS. 5A to 5D, black triangles show a state where the control valve V5 is open and white triangles show a state where the control valve V5 is closed. These points are the same also in embodiments to be described later. Although the detachment of a substrate SB from a blanket BL is illustrated and described here, the same applies also in the case of detaching a plate from the blanket BL and, in this case, the substrate may be replaced by the plate.

The detaching process shown in FIG. 4 is to detach the substrate SB from the blanket BL by applying the detaching process to a work WK in which the upper surface of the blanket BL and the lower surface of the substrate SB are held in close contact with each other via a pattern layer (not shown). This detaching process is performed by the CPU 91 executing a processing program stored in advance to control each unit.

Immediately after the detaching apparatus 1A is powered on or when a reset command is given to the control unit 9, the apparatus is initialized and each unit thereof is set in a predetermined initial state (Step S11). In the initial state, the mover 54 is actuated in response to an elevation command from the control unit 9 to elevate the movable body 52 including the sucking/supporting plate 523 to an upper end position. By this elevation, the engaging members 532 of all the suction units 53A to 53F are engaged with the sucking/supporting plate 532, elevated together with the sucking/supporting plate 523 and separated upwardly from the stage 30. Note that, since the mounted position of the engaging member 532 on the support pipes 531, i.e. the distance from the suction pads 536 to the engaging member 532 differs for each suction unit 53A to 53F in this embodiment, the suction pads 536 of the suction unit 53F, out of the suction units 53A to 53F, are closest to the stage 30 and the suction pads 536 are positioned at a longer distance from the stage 30 in a sequence of the suction units 53E to 53A.

The work WK is loaded to the above position on the stage 30 by an external conveyor robot or the like (Step S12). Then, the control unit 9 opens the control valves V31, V32 to give the negative pressure from the negative pressure supply unit 94 to the both suction grooves of the stage 30 and the work WK is sucked and held (Step S13: holding step) as shown in FIG. 5A.

Subsequent to that, the mover 54 is actuated in response to a lowering command from the control unit 9 to lower the movable body 52 including the sucking/supporting plate 523 as shown by a white arrow in FIG. 5B. At this time, the suction pads 536 of the suction unit 53F on the most downstream side in the X direction first come into contact with the upper surface of the work placed on the stage 30. Thereafter, although the movable body 52 is further lowered, the engaging member 532 is disengaged from the sucking/supporting plate 523 in the suction unit 53F and the suction unit 53F maintains the position thereof. On the other hand, in the remaining suction units 53E to 53A, an operation similar to that of the suction unit 53F is performed in this sequence. In this way, the suction pads 536 of all the suction units 53A to 53F come into contact with the upper surface of the work WK, i.e. the upper surface of the substrate SB (Step S14). Subsequent to that, the control unit 9 opens the control valve V5 to give the negative pressure from the negative pressure supply unit 94 to the suction pads 536 of the suction units 53A to 53F. This causes the upper surface of the work WK (upper surface of the substrate SB) to be sucked and held by the suction units 53A to 53F (Step S15). A negative pressure supply timing is not limited to this. For example, the negative pressure may be supplied while the movable body 52 is being lowered.

Subsequently, the mover 54 is actuated in response to an elevation command from the control unit 9 to elevate the movable body 52 including the sucking/supporting plate 523 as shown by a white arrow in FIG. 5C (Step S16). By the elevation of the movable body 52, the sucking/supporting plate 523 is first engaged with the engaging member 532 of the suction unit 53A on the most upstream side in the X direction. As the movable body 52 is further elevated, the suction pads 536 of the suction unit 53A are elevated in the (+Z) direction. At this time, a part of the substrate SB sucked by the suction pads 536 of the suction unit 53A, i.e. a sucked part, is detached from the blanket BL. Such partial detachment progresses in the (+X) direction as the movable body 52 is elevated (detaching step). That is, as shown in FIG. 5C, partial detachment by the suction units 53B, 53C is successively performed following the partial detachment by the suction unit 53A and the detachment of the substrate SB from the blanket BL progresses in the (+X) direction. As just described, in this embodiment, the (+X) direction corresponds to a “detachment progress direction” of the invention.

This partial detachment further progresses as the movable body 52 is elevated. When the sucking/supporting plate 523 reaches the upper end position as shown in FIG. 5D, all the suction units 53A to 53F are separated from the stage 30 in the (+Z) direction to detach the entire substrate SB from the blanket BL (total detachment) and position and hold the substrate SB at a position above the stage 30. When the control unit 9 confirms this (“YES” in Step S17), the elevation of the movable body 52 is stopped (Step S18).

Thereafter, the suction holding of the blanket BL by the suction grooves is released and the detached substrate SB and blanket BL are unloaded to the outside of the apparatus such as an external conveyor robot (Step S19) to complete the detaching process. The suction holding of the substrate SB by the suction pads 536 is released after the holding of the substrate SB by the conveyor robot or the like is released.

As described above, in the first embodiment, the movable body 52 including the sucking/supporting plate 523 is provided movably upward and downward in the vertical direction Z and each suction unit 53A to 53F is provided with the engaging member 532 engageable with the sucking/supporting plate 523. As shown in FIG. 5C, as the movable body 52 is elevated, the engaging members 532 of the suction units 53A to 53F are engaged with the sucking/supporting plate 523 in an array sequence of the suction units 53A to 53F in the X direction and the partial detachment is successively performed by the suction units 53A to 53F moving in the (+Z) direction while sucking the supper surface of the substrate SB. That is, the partial detachment is performed in the same sequence as the array sequence of the suction units 53A to 53F, whereby the substrate SB is detached from the blanket BL. By causing the movable body 52 to move in the (+Z) direction by the mover 54 in this way, a desired detaching process can be performed, with the result that the detaching apparatus 1A may be reduced in size as compared to conventional apparatuses in which a mover is provided for each suction unit, and apparatus cost can be reduced.

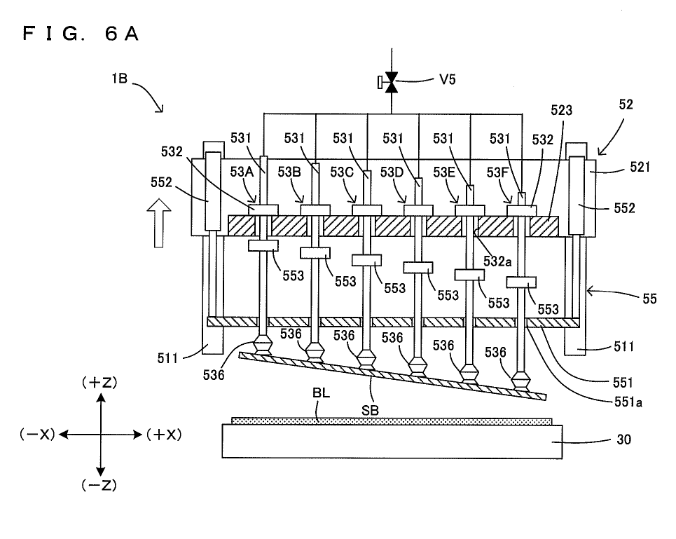

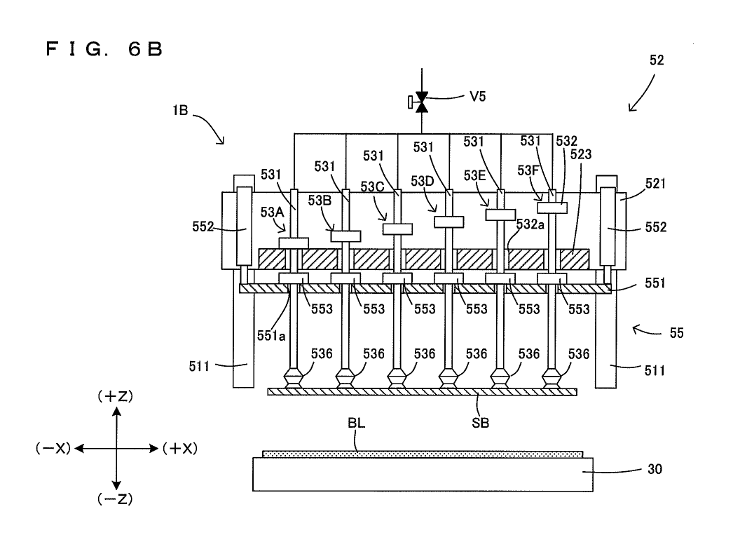

FIGS. 6 and 6B are diagrams showing a second embodiment of the detaching apparatus according to the invention, wherein FIG. 6A shows a status of each unit of the apparatus immediately after a detaching process is completed and FIG. 6B shows a status of each unit of the apparatus immediately before a substrate is unloaded. This detaching apparatus 1B largely differs from the first embodiment in that a posture adjusting unit 55 for adjusting the posture of a substrate sucked and held by suction units 53A to 53F from an oblique posture to a horizontal posture is added, and the other configuration is basically the same as in the first embodiment. Accordingly, description is made centering on points of difference. In the following description, the same components are denoted by the same reference signs and not described.

In this detaching apparatus 1B, the posture adjusting unit 55 is additionally equipped in the apparatus of the first embodiment. The posture adjusting unit 55 includes a movable body 551 for posture control movable in a vertical direction Z between a sucking/supporting plate 523 and suction pads 536 while remaining in a horizontal posture, two air cylinders 552 for moving the movable body 551 in the Z direction and engaging members 553 mounted on intermediate parts of support pipes 531. The movable body 551 has a plate shape and includes through holes 551a for the passage of the support pipes 531 similarly to the sucking/supporting plate 523. As shown in FIGS. 6A and 6B, the movable body 551 is horizontally arranged at a position below the sucking/supporting plate 523 with the respective support pipes 531 passed through the through holes 551a.

The air cylinders 552 function as a mover for moving the movable body 551 maintained in the horizontal posture in the Z direction. Specifically, cylinder sections of the respective air cylinders 552 are mounted on a plate 521 in both sides of the X direction while piston sections thereof extend vertically downward. When the detaching process is performed, the piston sections of the air cylinders 552 are expanded to retract the movable body 551 to a detaching process position as shown in FIG. 6A, whereby the detaching process can be performed as in the first embodiment. On the other hand, when the detaching process is completed, the piston sections of the air cylinders 552 are contracted to perform a posture adjustment in response to a posture adjustment command from a control unit 9 since the substrate SB is inclined. Specifically, as shown in FIG. 6B, the movable body 551 is elevated in the Z direction by the contraction of the piston sections, but the suction units 53F to 53A is engaged with the respective engaging members 553 in this sequence during that elevation and each of the suction units 53F to 53A is moved in the Z direction by a distance corresponding to an engagement start timing. Further, in this embodiment, distances between the suction pads 536 and the engaging members 553 in the Z direction are set to be substantially equal in the suction units 53A to 53F. As a result, the posture of the substrate SB is adjusted from an oblique posture to a substantially horizontal posture. The substrate SB is unloaded to the outside of the apparatus by an external conveyor robot or the like after the posture adjustment is made in this way.

As described above, since the detached substrate SB can be adjusted to the horizontal posture by providing the posture adjusting unit 55 in the second embodiment, the substrate SB is easily unloaded. Although the unloading of the detached substrate SB is described here, the same applies also when a detached plate is unloaded.

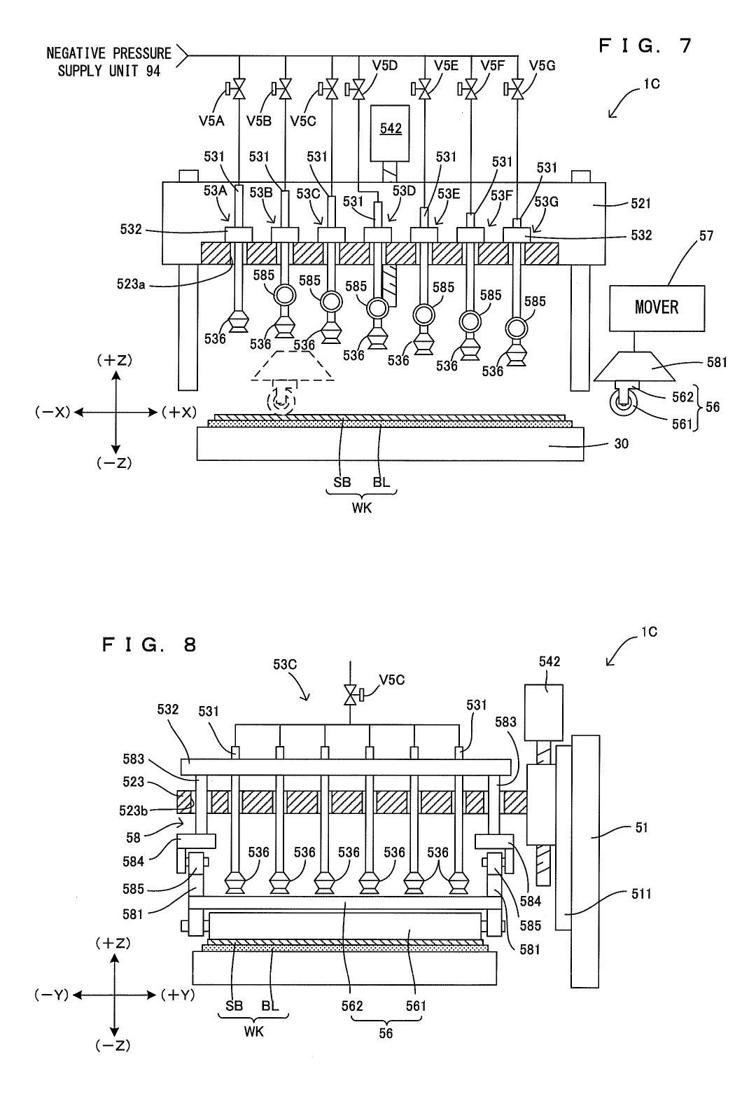

FIG. 7 is a diagram showing a third embodiment of the detaching apparatus according to the invention. Further, FIG. 8 is a side view of the detaching apparatus shown in FIG. 7. This detaching apparatus 1C largely differs from the first embodiment in that a roller unit 56 including a detaching roller 561 corresponding to an example of a “contact body” of the invention is added, a mover 57 for moving the roller unit 56 in an X direction and a cam mechanism 58 for elevating and lowering suction units 53A to 53G in a Z direction in conjunction with a movement of the roller unit 56 in the X direction are added, and a control valve V5A to V5G for switching the supply and the supply stop of a negative pressure is provided for each suction unit 53A to 53G, and the other configuration is basically the same as in the first embodiment. Accordingly, description is made centering on points of difference and the same components are denoted by the same reference signs and not described below.

In this third embodiment, the roller unit 56 is provided to stabilize a detaching operation as in the invention described in JP2016-10922A. As shown in FIG. 8, this roller unit 56 includes the detaching roller 561 having a length equivalent to a Y-direction size of a substrate SB and a roller supporting table 562 for pivotally supporting a rotary shaft of the detaching roller 561 from above. The roller supporting table 562 supports the detaching roller 561 such that a lowest end part of the detaching roller 561 is located at such a height position to be able to come into contact with the upper surface of a work WK, i.e. the upper surface of the substrate SB. Further, the roller supporting table 562 is movable in the X direction by being guided by an unillustrated X-direction guide while supporting the detaching roller 561 as described above. The mover 57 is coupled to this roller supporting table 562. The mover 57 moves the roller supporting table 562 in response to a movement command from a control unit 9, whereby the roller unit 56 moves in the X direction between a retracted position (solid-line position) distant in a (−X) direction from the work WK and a detachment start position (broken-line position).

Cams 581, 581 in the form of trapezoidal columns serving as constituent components of the cam mechanism 58 are provided for a (+Y) side surface area and a (−Y) side surface area out of the upper surface of the roller supporting table 562. In each cam 581, an upper surface is a horizontal surface and a (+X) side surface and a (−X) side surface thereof are finished into inclined surfaces wider apart toward bottom. These cams 581, 581 move together as the roller unit 56 is moved in the X direction. Except for the suction unit 53A arranged on a most upstream side in the X direction, each of the suction units 53B to 53G is provided with a cam follower unit to elevate and lower the suction unit 53B to 53G in the Z direction in conjunction of a movement of the cams 581, 581 in the X direction.

Here, the configuration of the cam follower unit provided in the suction unit 53C is described with reference to FIG. 8. The cam follower unit is as follows. Coupling members 583, 583 extend vertically downward, i.e. in the (−Z) direction from a (+X) side end part and a (−X) side end part of an engaging member 532. Each coupling member 583 is passed through a through hole 523b provided in a sucking/supporting plate 523. A cam follower unit supporting table 584 is attached to a lower end part of each coupling member 583. This cam follower supporting table 584 is arranged at a position above a movement path of the cam 581, and rotatably supports a cam follower 585 from above. The cam follower 585 comes into contact with the upper surface and the inclined surfaces of the cam 581. Thus, when the cams 581, 581 move to a position below the suction unit 53C as the roller unit 56 moves in the X direction, the cam followers 585 are engaged with the inclined surfaces and the horizontal surfaces of the cams 581, 581 and push the engaging member 532 upwardly via the cam follower unit. In this way, as shown in FIG. 8, all the suction pads 536 of the suction unit 53C are pulled upwardly regardless of the position of the sucking/supporting plate 523 in the Z direction and interference with the roller unit 56 can be prevented. On the other hand, when the roller unit 56 passes through the position below the suction unit 53C, the cam followers 585 and the cams 581 are disengaged in the suction unit 53C and the cam follower unit, the engaging member 532, all the support pipes 531 and all the suction pads 536 integrally move in the (−Z) direction by their own weights and the suction pads 536 of the suction unit 53C come into contact with the upper surface of the work WK (upper surface of the substrate SB). The cam mechanism 58 thus configured has a function of retracting the suction unit before the execution of partial detachment (hereinafter, referred to as a “pre-detachment suction unit”) upwardly only while the roller unit 56 passes through a sucked part of the work WK sucked by the suction pads 536 of the pre-detachment suction unit, i.e. a function of preventing the interference of the suction unit 53C with a movement of the roller unit 56 in the X direction. The cam follower unit is provided also in each of the other suction units 53B, 53D to 53G to prevent interference with the roller unit 56.

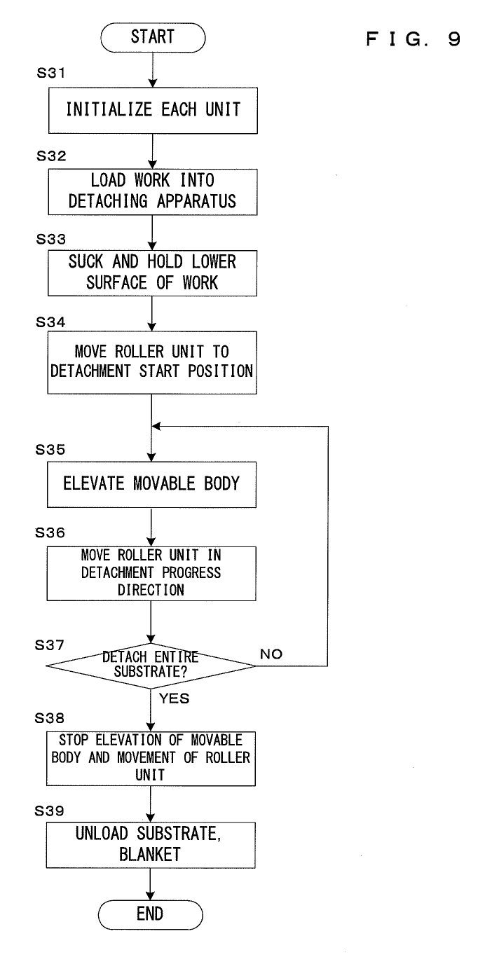

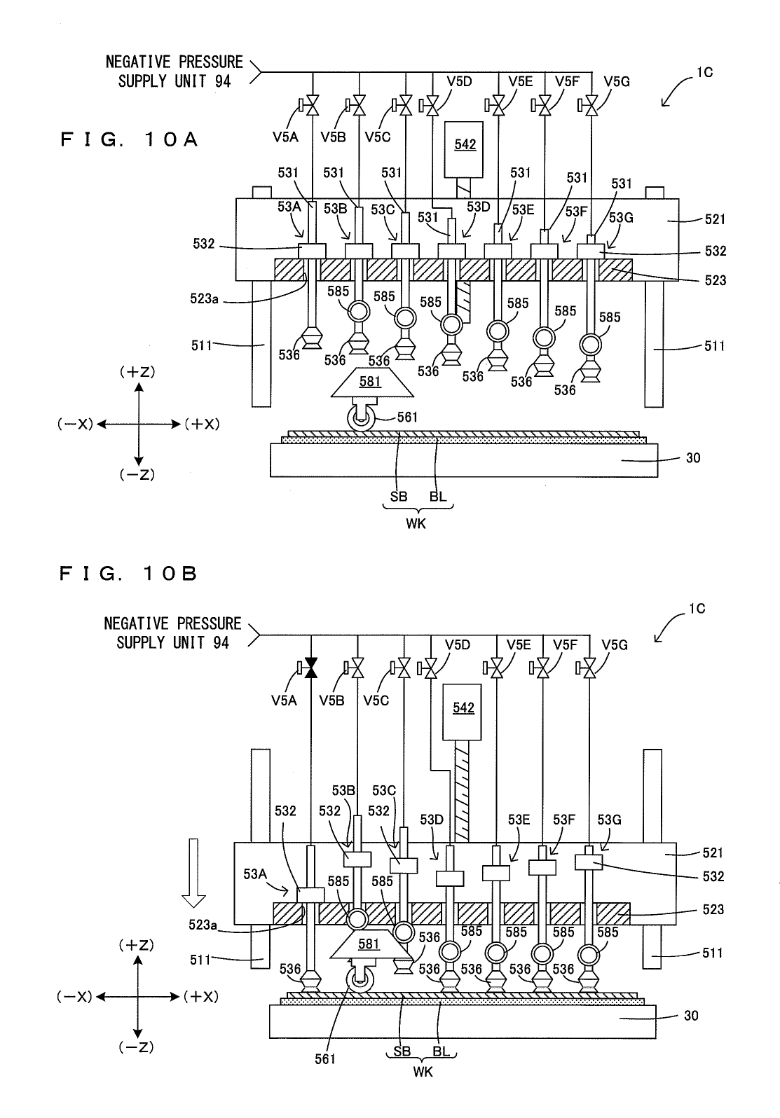

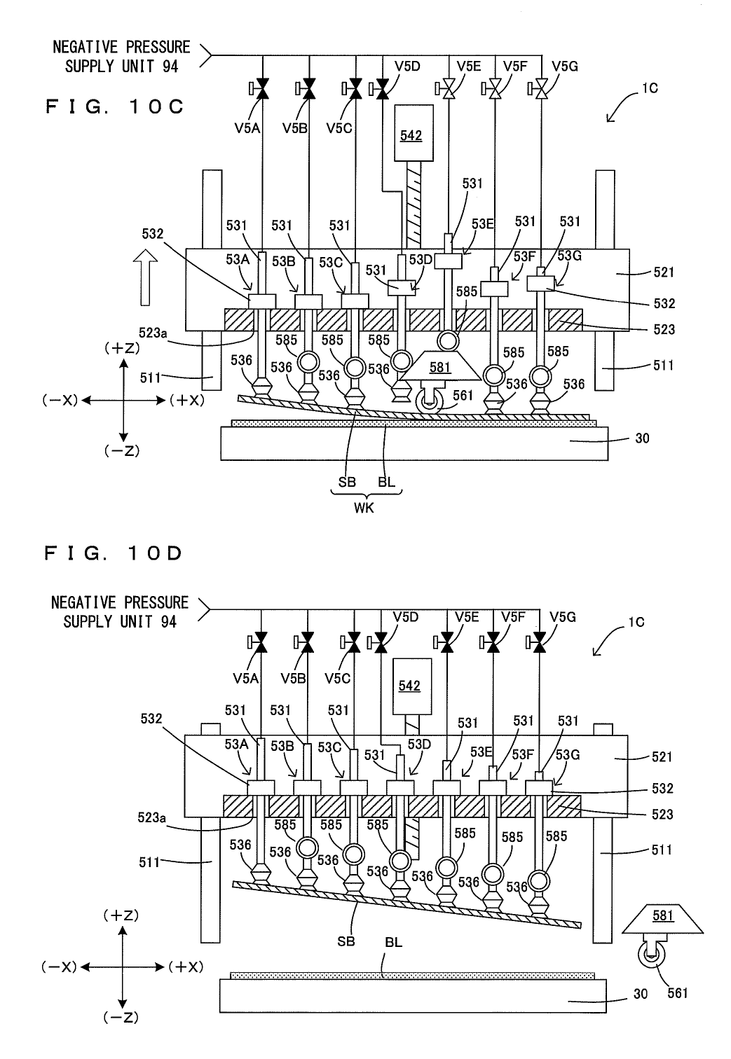

Next, the operation of the detaching apparatus 1C configured as described above is described with reference to FIGS. 9, 10A to 10D. FIG. 9 is a flow chart showing the detaching process in the third embodiment. FIGS. 10A to 10D are diagrams showing a positional relationship of each unit in each stage during the detaching process in the third embodiment. Immediately after the detaching apparatus 1C is powered on or when a reset command is given to the control unit 9, the apparatus is initialized and each unit thereof is set in a predetermined initial state (Step S31). In the initial state, as shown in FIG. 7, a mover 54 is actuated in response to an elevation command from the control unit 9 to elevate a movable body 52 including the sucking/supporting plate 523 to an upper end position. By this elevation, the engaging members 532 of all the suction units 53A to 53G are engaged with the sucking/supporting plate 532, elevated together with the sucking/supporting plate 523 and separated upwardly from the stage 30. Also in this embodiment, as in the first embodiment, the suction pads 536 of the suction unit 53G, out of the suction units 53A to 53G, are closest to the stage 30 and the suction pads 536 are positioned at a longer distance from the stage 30 in a sequence of the suction units 53F to 53A. Further, in the initial stage, the mover 57 is actuated in response to a retraction command from the control unit 9 to move and position the roller unit 56 to the retracted position together with the cams 581 as shown by solid line of FIG. 7.

The work WK is loaded to the above position on the stage 30 by an external conveyor robot or the like (Step S32). Then, the control unit 9 opens control valves V31, V32 to give a negative pressure from a negative pressure supply unit 94 to both suction grooves of the stage 30 and the work WK is sucked and held (Step S33: holding step).

Subsequent to that, the mover 54 is actuated in response to a movement command from the control unit 9 to move and position the roller unit 56 to the detachment start position together with the cams 581 (Step S34). Subsequent to that, the control valve V5A is opened in response to an opening command from the control unit 9 to give the negative pressure only to the suction pads 536 of the suction unit 53A. Further, in this state, the mover 54 lowers the movable body 52 including the sucking/supporting plate 523 as shown by a white arrow in FIG. 10B in response to a lowering command from the control unit 9. At this time, the suction pads 536 of the suction unit 53G on the most downstream side in the X direction first come into contact with the upper surface of the work placed on the stage 30. Thereafter, the movable body 52 is further lowered, but the engaging member 532 is disengaged from the sucking/supporting plate 523 in the suction unit 53G and the suction unit 53G maintains the position thereof. In the remaining suction units 53F to 53A, an operation similar to that of the suction unit 53G is performed in this sequence. When the suction pads 536 of the suction unit 53A reach the upper surface of the work WK, i.e. the upper surface of the substrate SB, the substrate SB is locally sucked and held by these suction pads 536. However, since the roller unit 56 and the cams 581 are located below the suction units 53B, 53C, the cam followers 585 coupled to the engaging members 532 of the suction units 53B, 53C are locked to the cams 581 and the suction pads 536 are located above the work WK. Particularly, since the detaching roller 561 is located right below the suction unit 53B as shown in FIG. 10B, the cam followers 585 are engaged with the upper surfaces of the cams 581 and the suction pads 536 are located at positions higher than the roller unit 56. In this way, the interference of the suction unit 53B and the roller unit 56 is prevented.

In this way, a part of the substrate SB, i.e. the sucked part is sucked and held by the suction unit 53A and a part of this sucked part near the (+X) side is pressed by the detaching roller 561. In this state, the mover 54 is actuated in response to an elevation command from the control unit 9 to elevate the movable body 52 including the sucking/supporting plate 523 as shown by a white arrow in FIG. 10C (Step S35). By the elevation of the movable body 52, the sucking/supporting plate 523 is first engaged with the engaging member 532 of the suction unit 53A on the most upstream side in the X direction. As the movable body 52 is further elevated, the suction pads 536 of the suction unit 53A are elevated in the (+Z) direction. At this time, the part of the substrate SB sucked by the suction pads 536 of the suction unit 53A, i.e. the sucked part, is detached from the blanket BL. Such partial detachment progresses in the (+X) direction as the movable body 52 is elevated (detaching step).

Further, the mover 57 is actuated to move the roller unit 56 in the (+X) direction together with the cams 581 in response to a movement command from the control unit 9 simultaneously with or with a slight delay from the start of the elevation of the movable body 52 (Step S36). In this way, the cams 581 are separated together with the roller unit 56 from the suction unit 53B in the (+X) direction and the suction pads 536 of the suction unit 53B descend to the upper surface of the work WK by their own weights. At this descent start timing, the control valve V5B is opened in response to an opening command output from the control unit 9 to give the negative pressure to the suction pads 536. Thus, the upper surface of the substrate SB is partially sucked and held when the suction pads 536 reach the upper surface of the work WK. At this time, a part near the (+X) side of the sucked part held by these suction pads 536 is pressed by the detaching roller 561. By the elevation of the movable body 52 after such a state is reached, the sucking/supporting plate 523 is engaged with the engaging member 532 of the suction unit 53B and the suction pads 536 of the suction unit 53B are elevated in the (+Z) direction. In this way, partial detachment by the suction unit 53B is performed and the detachment of the substrate SB progresses in the (+X) direction. Such partial detachment is performed in the suction units 53C, 53D, . . . as shown in FIG. 10C. When the sucking/supporting plate 523 reaches the upper end position as shown in FIG. 10D, all the suction units 53A to 53G are separated from the stage 30 in the (+Z) direction to detach the entire substrate SB from the blanket BL (total detachment) and position and hold the substrate SB at a position above the stage 30. Further, the cams 581 and the roller unit 56 are moved to the retracted position. If the control unit 9 confirms this (“YES” in Step S37), the elevation of the movable body 52 and the movement of the roller unit 56 are stopped (Step S38).

Thereafter, the suction holding of the blanket BL by the suction grooves is released and the detached substrate SB and blanket BL are unloaded to the outside of the apparatus by an external conveyor robot or the like (Step S39) to complete the detaching process. The suction holding of the substrate SB by the suction pads 536 is released after the holding of the substrate SB by the conveyor robot or the like is released.

As described above, also in the third embodiment, as the movable body 52 is elevated, the partial detachment is successively performed by the engaging members 532 of the suction units 53A to 53G being engaged with the sucking/supporting plate 523 in the array sequence of the suction units 53A to 53G in the X direction and moving in the (+Z) direction while sucking the upper surface of the substrate SB as in the first embodiment. By moving the movable body 52 in the (+Z) direction in this way, a desired detaching process can be performed, with the result that the detaching apparatus 1C can be reduced in size as compared to conventional apparatuses in which a mover is provided for each suction unit, and apparatus cost can be reduced. Further, since the partial detachment is performed with the vicinity of the sucked part sucked and held by the suction pads 536 pressed by the detaching roller 561, the detaching process can be stably performed.

As described above, in this embodiment, the blanket BL corresponds to an example of a “first plate-like member” of the invention, the substrate SB or plate corresponds to an example of a “second plate-like member” of the invention, and the upper and lower surfaces of the substrate SB or plate respectively correspond to an “other principal surface” and “one principal surface” of the invention. Further, the (+X) direction and (+Z) direction respectively correspond to a “detachment progress direction” and a “separation direction” of the invention. The stage 30 corresponds to an example of a “holder” of the invention. Further, the movable body 52, the mover 54 and the engaging members 532 respectively correspond to examples of a “first movable body”, a “first mover” and “first engaging members” of the invention and constitute a “detachment control unit” of the invention. The detaching roller 561, the mover 57 and the cam mechanism 58 respectively correspond to examples of a “contact body”, “a second mover” and a “third mover” of the invention. Further, the control valves V5A to V5G correspond to an example of a “suction switching unit” of the invention. Further, the support pipes 531 correspond to an example of a “supporting member” of the invention. Further, the movable body 551, the air cylinders 552 and the engaging members 553 respectively correspond to examples of a “second movable body”, a “fourth mover” and “second engaging members”.

Note that the invention is not limited to the above embodiments and various changes other than those described above can be made without departing from the gist of the invention. For example, the detaching process is performed by the six suction units 53A to 53F in the above first and second embodiments while being performed by the seven suction units 53A to 53G in the third embodiment. However, the number of the suction units is not limited to these and the invention can be applied to detaching apparatuses in general for performing a detaching process by a plurality of suction units.

Further, although the spacers 533 are used to adjust the height position of the suction pads for each suction unit in the above embodiments, means for adjusting the height positions is arbitrary without being limited to this. For example, screw holes may be respectively provided in a side surface on the (X) side of the engaging member 532 in correspondence with the respective support pipes 531, 531 passed through the engaging member 532 and the support pipes 531, 531 may be fixed to the engaging member 532 at a desired height position by locking the side surfaces of the support pipes 531 by screws inserted into the respective screw holes. By employing such a configuration, the above spacers become unnecessary and the height positions of the suction pads can be arbitrarily adjusted by a simple configuration.

In the second embodiment, the posture adjusting unit 55 is applied to the first embodiment. However, the same configuration as the posture adjusting unit 55 may be applied to the third embodiment to adjust the posture of the substrate SB or plate immediately after the detaching process from an oblique posture to a substantially horizontal posture. In this case, the substrate SB or plate can be easily unloaded to the outside of the apparatus by an external conveyor robot or the like after being posture-adjusted.

Further, as illustrated and described in the third embodiment, the invention may relate to a detaching apparatus for detaching a second plate-like member having one principal surface held in close contact with a first plate-like member from the first plate-like member in a detachment progress direction, the detaching apparatus including a holder configured to hold the first plate-like member, a plurality of suction units arrayed in the detachment progress direction and configured to suck the other principal surface of the second plate-like member, and a detachment control unit configured to cause the detachment of the second plate-like member to progress by performing partial detachment of detaching a sucked part of the second plate-like member sucked by the suction unit from the first plate-like member by moving the suction unit in a separation direction away from the holder in an array sequence of the plurality of suction units, a contact body configured to come into contact with the other principal surface of the second plate-like member on a side downstream of the suction unit performing the partial detachment in the detachment progress direction, a contact body mover configured to move the contact body in the detachment progress direction as the detachment of the second plate-like member progresses, and a pre-detachment mover configured to cause a pre-detachment suction unit before the execution of the partial detachment, out of the plurality of suction units held in contact with the other principal surface of the second plate-like member, to retract from the contact body at a timing, at which the contact body relatively approaches the pre-detachment suction unit, and return the pre-detachment suction unit to a position before the retraction after the passage of the contact body.

Further, the present invention may relate to a detaching method for detaching a second plate-like member having one principal surface held in close contact with the first plate-like member from the plate-like member in a detachment progress direction, the detaching method including a holding step of holding the first plate-like member by a holder, and a detaching step of performing partial detachment of detaching a sucked part of the second plate-like member sucked by a suction unit from the first plate-like member by moving the suction unit in a separation direction away from the holder while the other principal surface of the second plate-like member is sucked by the suction unit by a plurality of the suction units arrayed in the detachment progress direction, wherein, in the detaching step, the partial detachment is performed in a sequence from the suction unit located on a most upstream side toward the suction unit located on a most downstream side in the detachment progress direction while the holding step is continued, and a pre-detachment suction unit before the execution of the partial detachment, out of a plurality of section units held in contact with the other principal surface of the second plate-like member, is caused to retract from a contact body configured to come into contact with the other principal surface of the second plate-like member on a side downstream of the suction unit performing the partial detachment in the detachment progress direction at a timing, at which the contact body relatively approaches the pre-detachment suction unit, and returned to a position before the retraction after the passage of the contact body as the detachment of the second plate-like member progresses.

In the inventions thus configured, the contact body comes into contact with the other principal surface of the second plate-like member on the side downstream of the suction unit perming the partial detachment in the detachment progress direction, and moves in the detachment progress direction as the detachment of the second plate-like member progresses. When the contact body relatively approaches the pre-detachment suction unit, the pre-detachment suction unit is retracted from the contact body and returned to the position before the retraction after the passage of the contact body. Thus, the detaching process can be stably performed while the interference of the contact body and the suction units is avoided.

Note that, in the third embodiment, the mover 57 and the cam mechanism 58 respectively correspond to examples of the “contact body mover” and the “pre-detachment mover”.

This invention can be applied to detaching techniques in general for detaching a second plate-like member from a first plate-like member.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A detaching apparatus that detaches a second plate-like member, having one principal surface held in close contact with the first plate-like member, from the first plate-like member in a detachment progress direction, the apparatus comprising:
a holder configured to hold the first plate-like member;
a plurality of suction units arrayed in the detachment progress direction and configured to suck the other principal surface of the second plate-like member; and
a detachment control unit configured to cause the detachment of the second plate-like member to progress by performing partial detachment of detaching a sucked part of the second plate-like member sucked by the suction unit from the first plate-like member by moving the suction unit in a separation direction away from the holder in an array sequence of the plurality of suction units, wherein:
the detachment control unit includes:
a first movable body provided movably in the separation direction;
a first mover configured to move the first movable body in the separation direction; and
a plurality of first engaging members provided for each suction unit and configured to move the suction unit in the separation direction according to a movement of the first movable body by being engaged with the first movable body moving in the separation direction; and
a sequence of timings, at which the plurality of first engaging members are respectively engaged with the first movable body, is the same as the array sequence.

2. The detaching apparatus according to claim 1, further comprising:
a contact body configured to come into contact with the other principal surface of the second plate-like member on a side downstream of the suction unit performing the partial detachment in the detachment progress direction;
a second mover configured to move the contact body in the detachment progress direction as the detachment of the second plate-like member progresses; and
a third mover configured to cause a pre-detachment suction unit before the execution of the partial detachment, out of the plurality of suction units, to retract from the contact body at a timing, at which the contact body relatively approaches the pre-detachment suction unit, and move the pre-detachment suction unit after the passage of the contact body such that the pre-detachment suction unit comes into contact with the other principal surface of the second plate-like member.

3. The detaching apparatus according to claim 2, wherein:
the third mover includes a cam follower mounted on the pre-detachment suction unit and a cam mounted on the contact body and moves the pre-detachment suction unit with respect to the contact body by engaging the cam follower with the cam.

4. The detaching apparatus according to claim 2, wherein:
a suction switching unit configured to switch the supply and the supply stop of a negative pressure to the suction unit is provided for each of the suction units.

5. The detaching apparatus according to claim 1, wherein:
each suction unit includes a supporting member extending in the separation direction and a suction pad attached to a tip part of the supporting member and configured to come into contact with and suck the other principal surface of the second plate-like member;
the plurality of first engaging members are mounted on a rear end part of the supporting member in one-to-one-correspondence with the plurality of suction units; and
a distance from the suction pad to the first engaging member becomes longer in the array sequence.

6. The detaching apparatus according to claim 5, wherein:
each first engaging member is free to change the position thereof in the separation direction with respect to the rear end part of the supporting member.

7. The detaching apparatus according to claim 5, further comprising:
a second movable body provided movably in the separation direction between the first movable body and the suction pads;
a fourth mover configured to move the second movable body in the separation direction; and
a plurality of second engaging members mounted on intermediate parts of the supporting members in one-to-one-correspondence with the plurality of suction units and configured to move the suction unit in the separation direction according to a movement of the second movable body and align the plurality of suction units in a vertical direction according to a movement of the second movable body by being engaged with the second movable body moving in the separation direction.

8. A detaching method of detaching a second plate-like member, having one principal surface held in close contact with the first plate-like member, from the first plate-like member in a detachment progress direction, the method comprising:
a holding step of holding the first plate-like member by a holder; and
a detaching step of performing partial detachment of detaching a sucked part of the second plate-like member sucked by a suction unit from the first plate-like member by moving the suction unit in a separation direction away from the holder while the other principal surface of the second plate-like member is sucked by the suction unit by a plurality of the suction units arrayed in the detachment progress direction; wherein, in the detaching step,
a movable body is moved in the separation direction while the holding step is continued; and
an engaging member provided in each suction unit is engaged with the movable body moving in the separation direction and moved together with the movable body in the separation direction in a sequence from the suction unit located on a most upstream side toward the suction unit located on a most downstream side in the detachment progress direction, thereby performing the partial detachment.
